(19) United States
(12) Patent Application Publication
(10) Pub. No.: US 2013/0094397 A1
(43) Pub. Date: Apr. 18, 2013

(54) METHOD AND APPARATUS FOR LOCALIZED AND SCALABLE PACKET FORWARDING

(71) Applicants: Young Jin KIM, Basking Ridge, NJ (US); Marina THOTTAN, Westfield, NJ (US)

(72) Inventors: Young Jin KIM, Basking Ridge, NJ (US); Marina THOTTAN, Westfield, NJ (US)

(21) Appl. No.: 13/415,295

(22) Filed: Mar. 8, 2012

Related U.S. Application Data
(60) Provisional application No. 61/547,708, filed on Oct. 15, 2011.
(60) Provisional application No. 61/562,339, filed on Nov. 21, 2011.

(51) Int. Cl. H04L 12/28; H04L 12/56

(52) U.S. Cl. 370/254

(57) ABSTRACT

A packet forwarding determination capability is disclosed herein. The packet forwarding determination capability enables determination of handling of a packet at a current node of a network. A set of candidate neighbor nodes is determined for the current node from a representation of respective locations of the neighbor nodes. The set of candidate neighbor nodes includes each of the neighbor nodes located at least within a circle defined within the representation and having a diameter defined by a line between the current node and a destination node of the packet. The routing of the packet at the current node is determined using the set of candidate neighbor nodes. The routing of the packet may include forwarding the packet toward a next-hop node or identifying the current node as being the intended destination of the packet.

### CROSS REFERENCE TO RELATED APPLICATION

This application aims the benefit of U.S. Provisional Patent Application Ser. No. 61/547,708, filed Oct. 15, 2011, and U.S. Provisional Patent Application Ser. No. 61/562,339, filed Nov. 21, 2011, each of which is hereby incorporated herein by reference in its entirety.

### TECHNICAL FIELD

The invention relates generally to communication networks and, more specifically but not exclusively, forwarding of packets within communication networks.

### BACKGROUND

Many types of schemes exist for performing packet forwarding within overlay networks. A first type of scheme includes performing packet forwarding using Dynamic Hash Tables (DHTs). A second type of scheme includes performing packet forwarding using Greedy Forwarding processes. While many such schemes may have associated advantages, the maximum latency of packet forwarding in such schemes typically is unbounded.

### SUMMARY

Various deficiencies in the prior art are addressed by embodiments for improving packet forwarding in communication networks.

In one embodiment, an apparatus is provided for determining packet routing at a current node having a plurality of neighbor nodes associated therewith. The apparatus includes a processor and a memory communicatively coupled to the processor. The processor is configured to determine a set of candidate neighbor nodes of the current node from a representation of respective locations of the neighbor nodes, where the set of candidate neighbor nodes includes each of the neighbor nodes located at least within a circle defined within the representation and having a diameter defined by a line between the current node and a destination node of the packet. The processor also is configured to determine packet routing at the current node using the set of candidate neighbor nodes.

In one embodiment, a computer-readable storage medium stores instructions which, when executed by a computer, cause the computer to perform a method for determining packet routing at a current node having a plurality of neighbor nodes associated therewith. The method includes determining a set of candidate neighbor nodes of the current node from a representation of respective locations of the neighbor nodes, where the set of candidate neighbor nodes includes each of the neighbor nodes located at least within a circle defined within the representation and having a diameter defined by a line between the current node and a destination node of the packet. The method also includes determining packet routing at the current node using the set of candidate neighbor nodes.

In one embodiment, a method is provided for determining packet routing at a current node having a plurality of neighbor nodes associated therewith. The method includes determining a set of candidate neighbor nodes of the current node from a representation of respective locations of the neighbor nodes, where the set of candidate neighbor nodes includes each of the neighbor nodes located at least within a circle defined within the representation and having a diameter defined by a line between the current node and a destination node of the packet. The method also includes determining packet routing at the current node using the set of candidate neighbor nodes.

### BRIEF DESCRIPTION OF THE DRAWINGS

The teachings herein can be readily understood by considering the following detailed description in conjunction with the accompanying drawings, in which:

FIG. 1 depicts an exemplary triangulated overlay network supporting a Reduced Greedy Forwarding (RGF) capability;

FIG. 2 depicts one embodiment of a method for determining routing of packets at a current node;

FIG. 3 depicts the triangulated overlay network of FIG. 1, illustrating circles which may be defined for use in determining sets of candidate neighbor nodes as depicted and described with respect to the method of FIG. 2;

FIG. 4 depicts one embodiment of a method for determining routing of packets at a current node using a set of candidate neighbor nodes of the current node;

FIG. 5 depicts one embodiment of a method for classifying candidate neighbor nodes into three disjoint subsets of candidate neighbor nodes;

FIG. 6 depicts the geometry associated with the candidate neighbor node classification process depicted and described with respect to FIG. 5;

FIG. 7 depicts one embodiment of a method for determining routing of packets at a current node using three disjoint subsets of candidate neighbor nodes as determined in FIG. 5;

FIG. 8 depicts one embodiment of a method for classifying candidate neighbor nodes into four disjoint subsets of candidate neighbor nodes;

FIG. 9 depicts one embodiment of a method for determining the second subset of candidate neighbor nodes of the current node within the context of the method for classifying candidate neighbor nodes into four disjoint subsets of candidate neighbor nodes of FIG. 8;

FIG. 10 depicts an exemplary triangle walk between a current node and a destination node;

FIG. 11 depicts one embodiment of a method for determining routing of packets at a current node using four disjoint subsets of candidate neighbor nodes as determined in FIGS. 8 and 9; and

FIG. 12 depicts a high-level block diagram of a computer suitable for use in performing the functions described herein.

To facilitate understanding, identical reference numerals have been used, where possible, to designate identical elements that are common to the figures.

### DETAILED DESCRIPTION

In general, a Reduced Greedy Forwarding (RGF) capability, which also may be referred to herein as a packet forwarding determination capability, is depicted and described herein, although various other capabilities also may be presented herein.

In at least some embodiments, the RGF capability provides a process that, given any source-destination pair in a network, tends to reduce or even minimize maximum delivery latency associated with packet forwarding between the source-destination pair.

In at least some embodiments, the RGF capability provides a process that, given any source-destination pair (s,t) in a network, reduces the maximum delivery latency associated with forwarding of packets between s and t to be less than 2.4 times Euclidean distance between s and t in the worst case, thereby providing significant improvement over existing packet forwarding solutions which have a maximum delivery latency of N time Euclidean distance in the worst case (where N is the total number of nodes in the network).

In at least some embodiments, the process reduces or minimizes maximum delivery latency associated with packet forwarding between a given source-destination pair in a network without a global view of network conditions in the network and, further, without wasting network resources of the network for computation.

Although primarily depicted and described herein with the context of using the RGF capability within a triangulated overlay network satisfying the properties of a Delaunay Triangulation (DT), it is noted that the RGF capability may be utilized in more general networks which do not satisfy the properties of a DT.

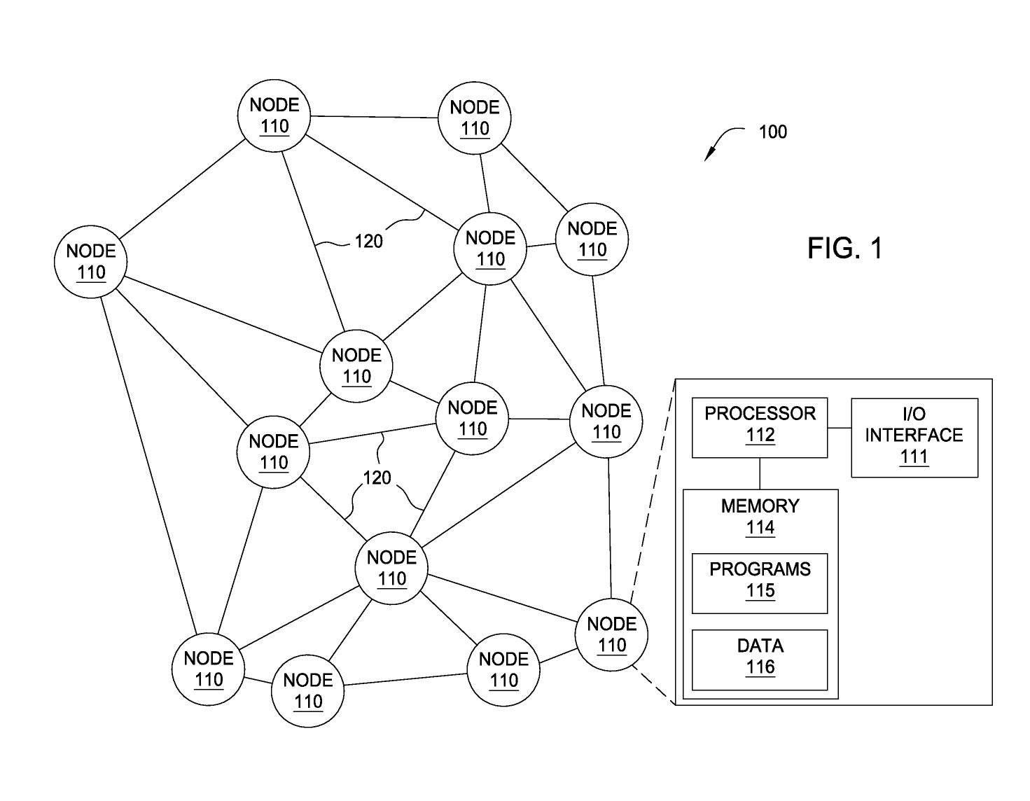

FIG. 1 depicts an exemplary triangulated overlay network supporting a Reduced Greedy Forwarding (RGF) capability.

As depicted in FIG. 1, triangulated overlay network 100 includes a plurality of nodes 110 (collectively, nodes 110) configured to communicate via a plurality of communication paths 120 (collectively, communication paths 120).

The triangulated overlay network 100 may be any suitable type of overlay network. In general, an overlay network is typically a computer network which is built over an underlying network. For example, distributed networks, such as client-server applications, peer-to-peer systems, cloud computing, and the like, are often considered to be overlay networks.

The nodes 110 may include any types of nodes which may participate in a triangulated overlay network, which may depend on the type of triangulated overlay network being implemented. For example, the nodes 110 may include end user devices (e.g., desktop computers, laptop computers, tablet computers, smart phones, and the like), network devices (e.g., servers and the like), monitoring devices, sensors, and the like, as well as various combinations thereof.

The communication paths 120 are logical paths via which nodes 110 may communicate. The communication paths 120 may be established via any suitable type(s) of underlying communication networks (e.g., public IP-based networks such as the Internet, private IP-based networks, and the like). Similarly, the communication paths 120 between nodes 110 may traverse any suitable type(s) and number(s) of underlying communications devices (e.g., routers, switches, and the like) and any suitable type(s) and number(s) of underlying physical links.

In one embodiment, a node 110 is configured to perform various functions of the RGF capability.

In one embodiment, for a given current node 110, the current node 110 is configured to determine routing of packets for a given destination node, which may include (1) identifying a next-hop node for the given destination node 110 for packets to be transmitted from the current node 110 toward the given destination node 110 or (2) identifying itself as being the given destination node 110 for packets intended for the given destination node 110.

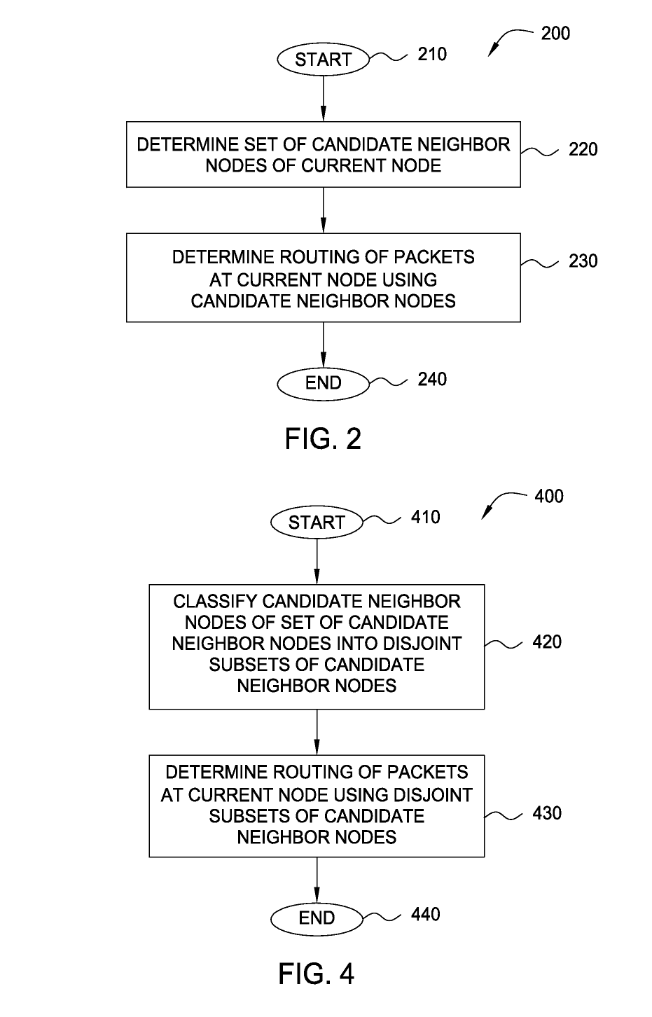

In one embodiment, a current node 110 determines routing of packets for a given destination node 110 as depicted and described with respect to method 200 of FIG. 2. In this embodiment, the current node 110 may be configured with information for use in executing method 200 of FIG. 2 and associated methods which may be performed in conjunction with and/or as part of method 200 of FIG. 2.

In one embodiment, a current node 110 has information regarding a given coordinate space and, within the context of the given coordinate space, knows its own location within the given coordinate space and knows the respective locations of other nodes of the triangulated overlay network within the given coordinate space.

The given coordinate space may be any suitable type of coordinate space (e.g., a two-dimensional coordinate space, a three-dimensional Euclidean coordinate space, a spherical coordinate space, and the like).

The current node 110 may discover its own location within the given coordinate space (e.g., using GPS or any other suitable location determination capability) or may be configured with its location within the given coordinate space (e.g., when it is deployed, by a management system, and the like).

The current node 110 may discover the locations of its neighbor nodes 110 in triangulated overlay network 100 and/or may be configured with the locations of its neighbor nodes 110 in triangulated overlay network 100. It is noted that the set of neighbor nodes 110 of a given current node 110 may depend on one or more factors, such as the type of triangulated overlay network 100, the type of nodes 110 of triangulated overlay network 100, the types of communication paths 120 used to facilitate communications between nodes 110, and the like, as well as various combinations thereof. For example, for wireline nodes 110, the neighbor nodes 110 of a given node 110 may include each of the nodes 110 with x hops of the given node 110. For example, for wireless nodes 110, the neighbor nodes of a given node 110 may include each of the nodes 110 within a particular wireless range associated with the given node 110.

The current node 110 is configured to construct a graph from the perspective of the current node 110, where the graph represents the layout of at least a portion of the triangulated overlay network 100 from the perspective of the current node 110. The graph is constructed by the current node 110 using the location information. The current node 110 is configured to determine routing of packets for a given destination node 110 (e.g., which, as noted above, may include identifying a next-hop node for the packet for the given destination node 110 or identifying itself as being the given destination node 110) using the constructed graph. It is noted that the graph is one example of a type of representation which may be used to represent the layout of at least a portion of triangulated overlay network 100 and that any other suitable type of representation may be used to represent the layout of at least a portion of triangulated overlay network 100 (and, therefore, that the references herein to the “graph” may be read more generally as references to a “representation”).

As depicted in FIG. 1, an exemplary current node 110 includes a processor 112, a memory 114, and an input-output (I/O) interface 118. The memory 114 and I/O interface 118 are coupled to processor 112. The memory 114 stores information suitable for use in providing various functions of the RGF capability, including programs 115 and data 116. The programs 115 may include one or more programs implementing one or more of the processes depicted and described with respect to FIGS. 2, 4, and 7. The data 116 may include one or more of location information associated with current node 110, one or more graphs constructed by the current node 110, and the like, as well as various combinations thereof. The exemplary current node 110 may include any other suitable modules, support circuits, and the like as may be necessary or desirable for implementing the current node 110. It is noted that such an implementation of a current node 110 is merely exemplary, and that any other suitable implementation may be used.

Although primarily depicted and described herein with respect to embodiments in which a current node constructs a graph for use in providing functions of the RGF capability, it is noted that in one or more other embodiments the graph may be constructed by another device (e.g., a central controller, management, system, and the like) and provided to the current node 110 for use by the current node in providing various functions of the RGF capability.

The RGF capability may be better understood by first describing various properties of embodiments of the RGF capability.

The RGF capability, in at least some embodiments, relies upon an assumption that a Delaunay Triangulation (DT), for a given set V of overlay nodes 110 in triangulated overlay network 100, can be built in either a distributed or centralized manner. A DT is a triangulation DT(V) such that no node in V is inside the circumcircle of any triangle in DT(V). It is a maximal planar graph where no edge crosses another edge in DT and, also, adding any edge (on the given node set) would destroy planarity. The use of a DT substrate to provide the RGF capability within triangulated overlay network 100 may have a number of advantages as follows: (1) sparse-degree network graphs are known to have efficient forwarding schemes for small-size look-up memory, short path-length, and small number of path hops (e.g., the average degree of DT is less than six, as provably shown in Corollary 1) (2) interesting graph asses (e.g., minimum spanning tree, nearest neighbor graph, and the like) having some desirable properties are sub-graphs of DT (e.g., DT can be built in a distributed and incremental manner since, for a newly given node, finding the closest neighbor already placed in DT may be performed by simply embedding the nearest neighbor graph into DT); and (3) DT can be extended to a multi-dimensional. As noted above, corollary 1 is that, in DT, average node degree (the average number of neighbor nodes) is less than six, which may be proven as follows: from the fact that DT is maximal planar, and from DT's triangulated property, it follows that if DT has v vertices with v>2, then it has precisely 3v-6 undirected edges, which further indicates that the number of directed edges in DT is 6v-12, thereby indicating that the average node degree in DT is [(6v-12)/v<6].

The RGF capability may be better understood by defining terminology to be used in conjunction with the description of the various embodiments of the RGF mechanism. First, v₀ is denoted as the source node, t is denoted as the destination node, and vᵢ is denoted as the i^{th} node visited during forwarding (and also is referred to herein as current node vᵢ). Second, d(x, y) is defined as the Euclidean distance between two nodes x and y. Third, p(v₀, t) is defined as the summation of Euclidean distances of all edges constituting forwarding path (v₀,t). Finally, αᵢ and βᵢ denote angle vᵢ₊₁vᵢt and vᵢ₊₁tvᵢ, respectively.

FIG. 2 depicts one embodiment of a method for determining routing of packets at a current node.

At step 210, method 200 begins.

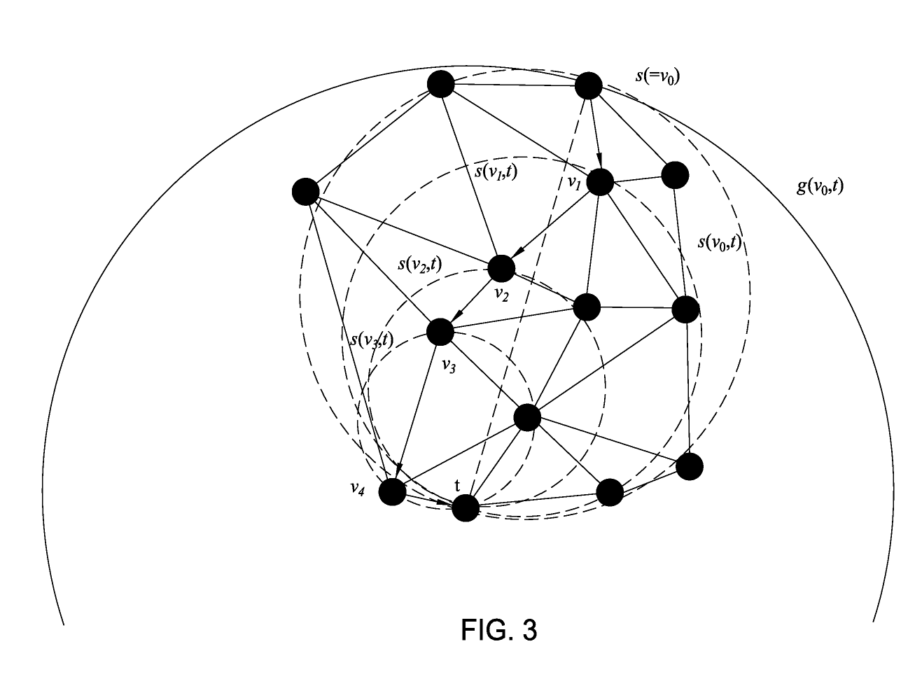

At step 220, a set of candidate neighbor nodes (denoted herein as C(vᵢ)) of the current node (denoted herein as vᵢ) is determined. The set of candidate neighbor nodes may be determined from a graph representative of respective locations of the neighbor nodes of the current node. In one embodiment, the set of candidate neighbor nodes C(vᵢ)) of current node vᵢ includes all neighbor nodes of current node vᵢ that are at least within (and, optionally, also on) a circle, defined within the graph, having a diameter defined by a line between the current node and a destination node of the packet (i.e., by the line d(vᵢ, t)). This type of circle is depicted and described herein with respect to FIG. 3.

At step 230, routing of packets at the current node is determined using the set of candidate neighbor nodes C(vᵢ). In one embodiment, determining routing of packets at the current node using the set of candidate neighbor nodes C(vᵢ) is performed using a process such as method 400 depicted and described with respect to FIG. 4.

At step 240, method 200 ends.

Although depicted and described herein as ending (for purposes of clarity), it is noted that one or more additional steps may be performed following determination of the routing of the packet at the current node. For example, the current node v, may store the result in a routing table for use in determining routing of packets intended for destination node t (e.g., routing packets toward the next-hop node determined for the destination node t or identifying the current node vᵢ as being the destination node t). For example, where the current node vᵢ has a packet intended for delivery to destination node t, the current node vᵢ may propagate the packet toward the next-hop node determined for the destination node t. It is noted that various other suitable steps may be performed.

FIG. 3 depicts the triangulated overlay network of FIG. 1, illustrating circles which may be defined for use in determining sets of candidate neighbor nodes as depicted and described with respect to the method of FIG. 2.

As depicted in FIG. 3, a packet is routed from a source node (s, and also denoted as v₀) to a destination node (t) via four intermediate nodes v₁, v₂, v₃, and v₄ along a path defined as follows: s, v₁, v₂, v₃, v₄, t. At a given current node vᵢ of the path p(s,t), the current node vᵢ executes the method 200 of FIG. 2 for determining a set of candidate neighbor nodes C(vᵢ) of the current node vᵢ for destination node t, and for selecting a next-hop node from the set of candidate neighbor nodes C(vᵢ) of the current node vᵢ. As described herein, the set of candidate neighbor nodes C(vᵢ) of current node vᵢ includes all neighbor nodes of current node vᵢ that are within or on a circle having a diameter defined by the line d(vᵢ, t). As depicted in FIG. 3, five such circles are depicted for the triangulated overlay network 100 (illustratively, one for each of the nodes v_{o through v}₄); however, for purposes of clarity, only one such diameter line is depicted (illustratively, diameter line d(v₀, t) used when source node v₀ executes method 200 of FIG. 2). The source node v₀, using the circle identified as ζ(v₀, t) and whose diameter is line (v₀, t), identifies two candidate neighbor nodes and selects candidate neighbor node v₁ as the next-hop node for routing packets from itself toward destination node t. Similarly, the first intermediate node v₁, using the circle identified as ζ(v₁, t) and whose diameter is line (v₁, t), identifies three candidate neighbor nodes and selects candidate neighbor node v₂ as the next-hop node for routing packets from itself toward destination node t. This process is repeated at intermediate nodes v₂ and v₃, each of which identifies only a single candidate neighbor node and selects that candidate neighbor node as its next-hop node toward destination node t, respectively. The final intermediate node v₄, using the circle identified as ζ(v₄, t) and whose diameter is line (v₄, t), identifies the destination node t as the next-hop node for routing packets from itself to destination node t. Finally, the destination node t identifies itself as the destination node for packets routed along the path from current node vᵢ to destination node t.

It is noted that various embodiments of the RGF capability depicted and described herein are in contrast to Greedy Forwarding (GF) algorithms in which, for each forwarding step i, among neighbor nodes within the circle whose radius is the line (vᵢ, t), the next-hop node is always the node closest to destination node t. An exemplary circle is depicted in FIG. 3 for source node v₀ as circle φ(vᵢ, t).

As indicated with respect to FIG. 2 and FIG. 3, a current node vᵢ selects a next-hop node for a given destination node from a set of candidate neighbor nodes.

FIG. 4 depicts one embodiment of a method for determining routing of packets at a current node using a set of candidate neighbor nodes of the current node. As noted above, in one embodiment the method 400 is suitable for use as step 230 of FIG. 2.

At step 410, method 400 begins.

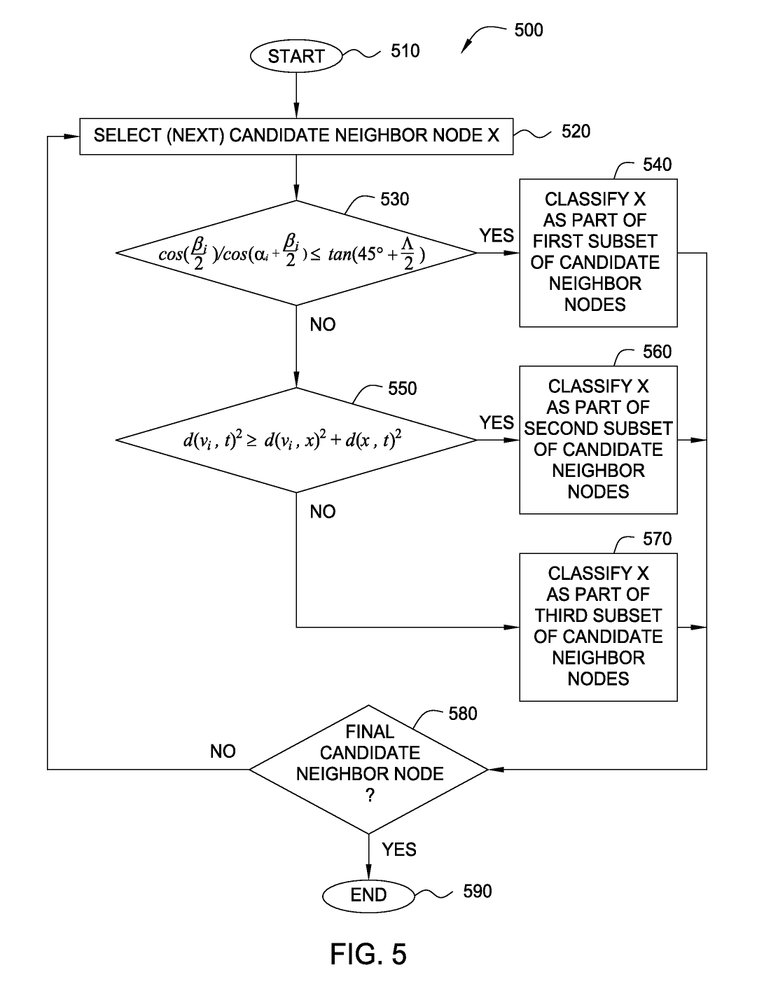

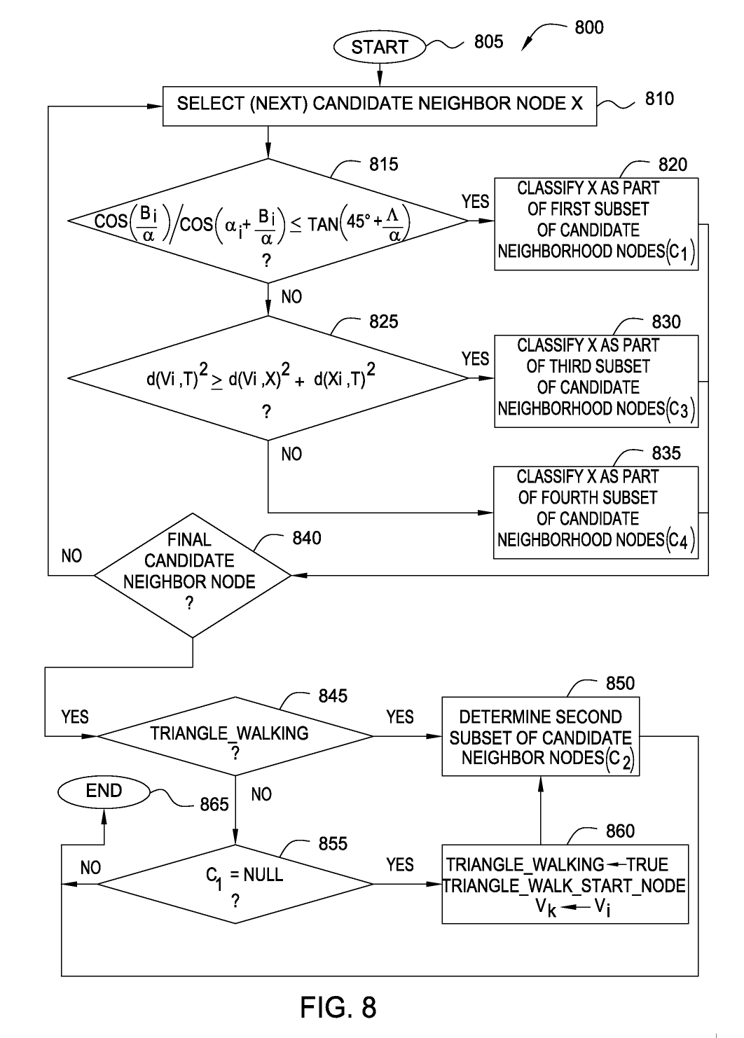

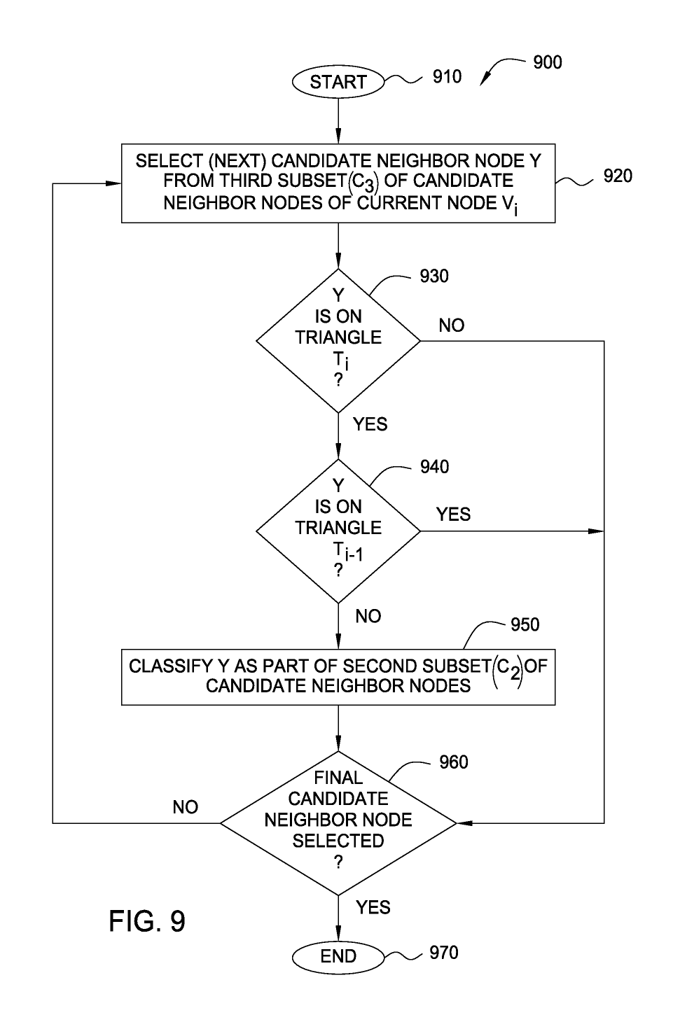

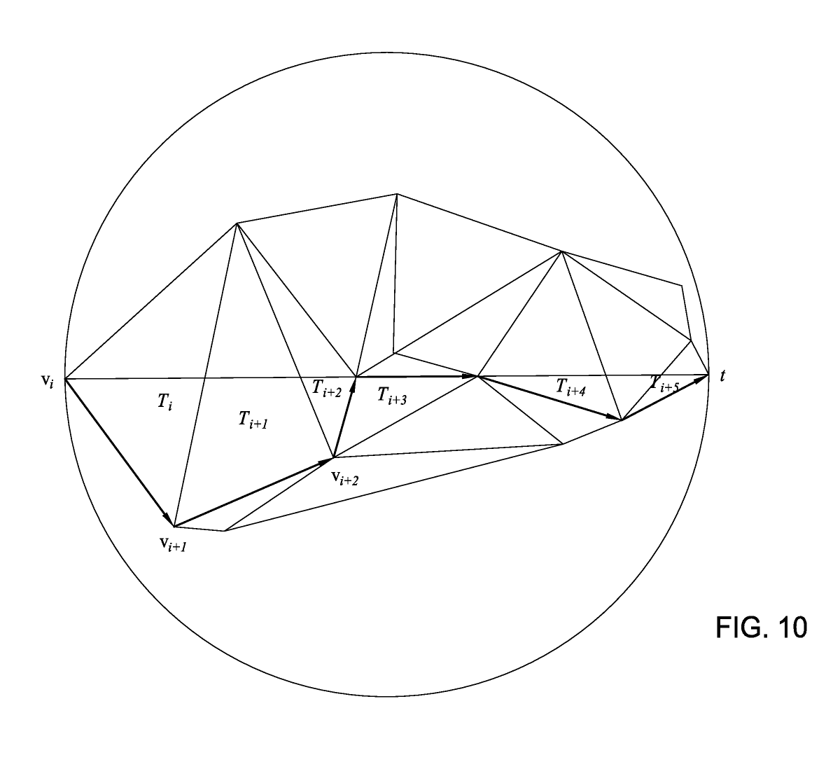

At step 420, the candidate neighbor nodes of the set of candidate neighbor nodes C(vᵢ) are classified into disjoint subsets of candidate neighbor nodes. In one embodiment, the candidate neighbor nodes of the set of candidate neighbor nodes C(vᵢ) are classified into three disjoint subsets of candidate neighbor nodes (denoted as first subset N₁(vᵢ), second subset N₂(vᵢ), and third subset N₃(vᵢ), respectively) using a process such as method 500 depicted and described with respect to FIG. 5. In one embodiment, the candidate neighbor nodes of the set of candidate neighbor nodes C(vᵢ) are classified into four disjoint subsets of candidate neighbor nodes (denoted as first subset C₁(vᵢ), second subset C₂(vᵢ), third subset C₃(vᵢ), and fourth subset C₄(vᵢ), respectively) using a process such as method 800 depicted and described with respect to FIG. 8 and, optionally, a process such as method 900 depicted and described with respect to FIG. 9.

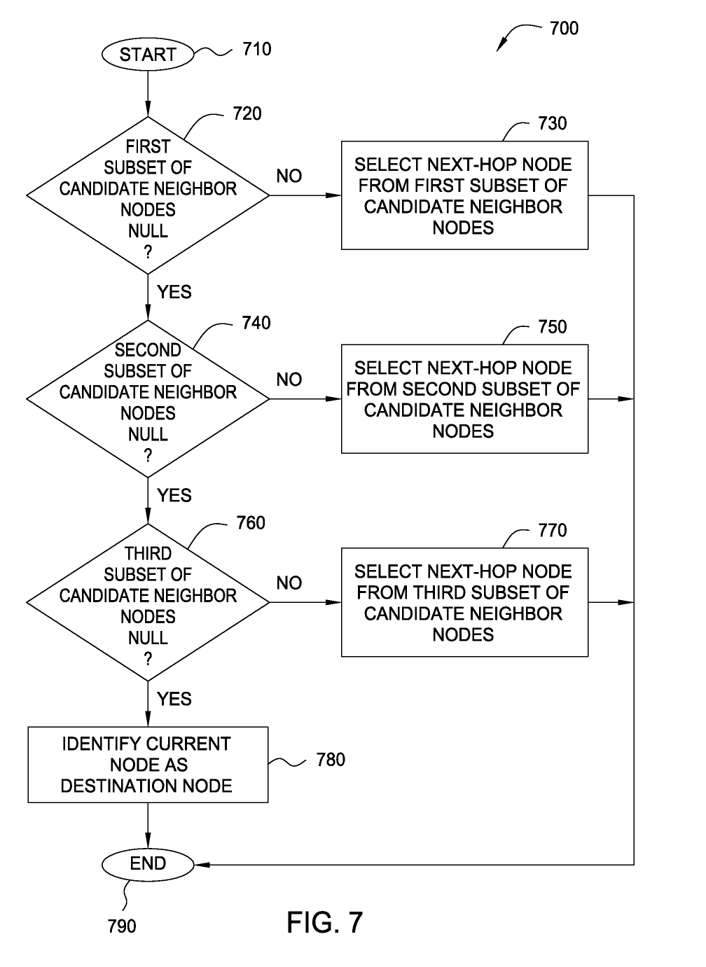

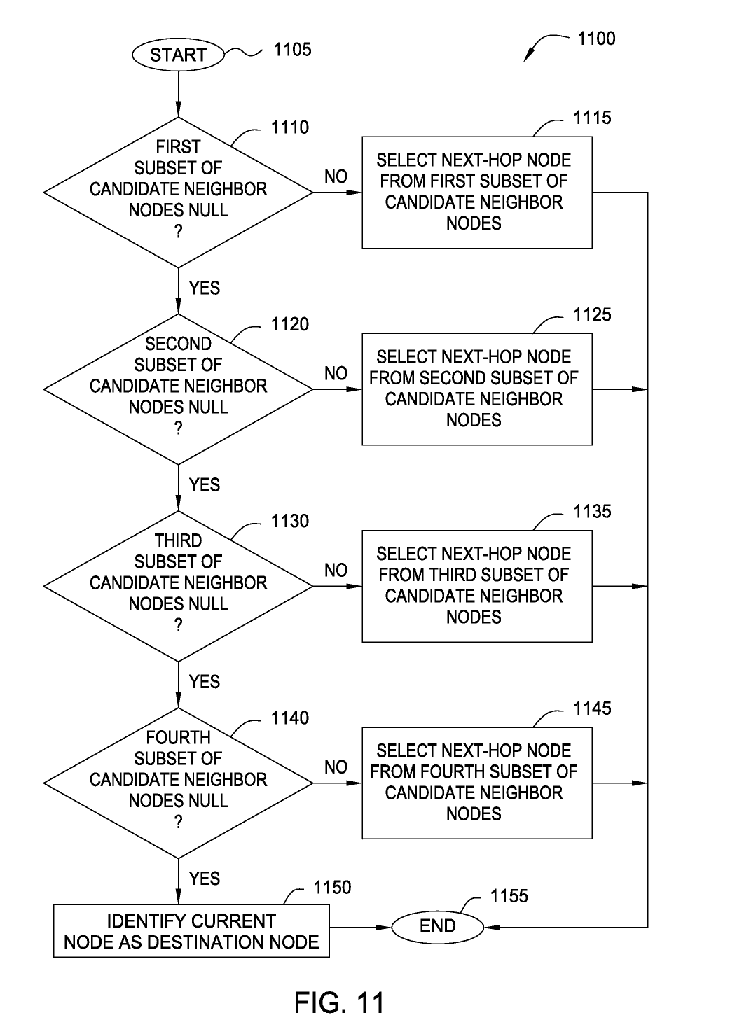

At step 430, routing of packets at the current node is determined using the determined subsets of candidate neighbor nodes. In one embodiment, in which the candidate neighbor nodes of the set of candidate neighbor nodes C(vᵢ) are classified into three disjoint subsets of candidate neighbor nodes, routing of packets at the current node using the three subsets of candidate neighbor nodes is determined using a process such as method 700 depicted and described with respect to FIG. 7. In one embodiment, in which the candidate neighbor nodes of the set of candidate neighbor nodes C(vᵢ) are classified into four disjoint subsets of candidate neighbor nodes, routing of packets at the current node using the four subsets of candidate neighbor nodes is determined using a process such as method 1100 depicted and described with respect to FIG. 11.

At step 440, method 400 ends.

Although depicted and described herein as ending (for purposes of clarity), it is noted that one or more additional steps may be performed following determining of packet routing at the current node (e.g., additional steps such as those depicted and described as being performed following method 200 of FIG. 2).

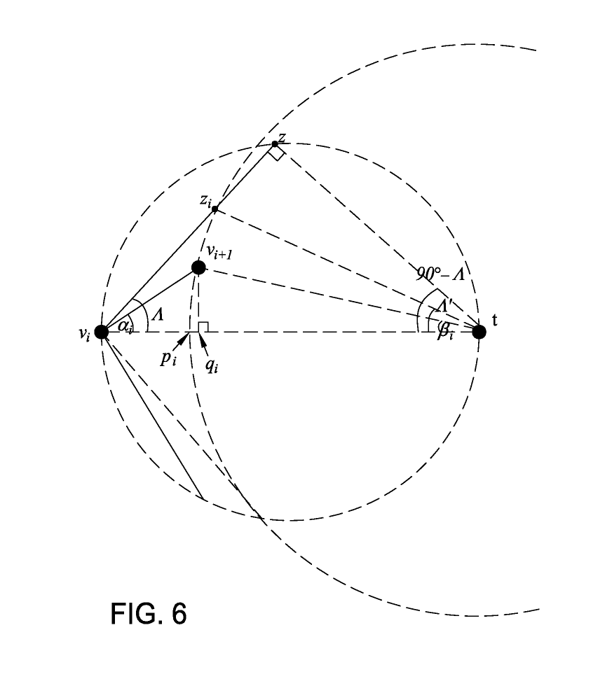

FIG. 5 depicts one embodiment of a method for classifying candidate neighbor nodes into three disjoint subsets of candidate neighbor nodes. As noted above, in one embodiment, method 500 is suitable for use as step 420 of FIG. 4. It is noted that various angles and other related properties depicted and described with respect to FIG. 5 may be better understood by way of reference to FIG. 6.

At step 510, method 500 begins.

At step 520, a (next) candidate neighbor node x is selected from the set of candidate neighbor nodes C(vᵢ).

At step 530, a determination is made as to whether [[(cos(βᵢ/2))/(cos(αᵢ+βᵢ/2))≦tan(45°+(Λ/2))].

If [[cos(βᵢ/2))/(cos(αᵢ+βᵢ/2))≦tan(45°+(Λ/2))] is true, method 500 proceeds to step 540, at which point candidate neighbor node x is classified as being part of the first subset N₁(vᵢ) of candidate neighbor nodes of current node vᵢ. From step 540, method 500 proceeds to step 580.

If [[(cos(βᵢ/2))/(cos(αᵢ+βᵢ/2))≦tan(45°+(Λ/2))] is false, method 500 proceeds to step 550.

At step 550, a determination is made as to whether [d(vᵢ,t)²≧d(vᵢ,x)²+d(x,t)²].

If [d(vᵢ,t)²≧d(vᵢ,x)²+d(x,t)²] is true, method 500 proceeds to step 560 at which point candidate neighbor node x is classified as being part of the second subset N₂(vᵢ) of candidate neighbor nodes of current node vᵢ. From step 560, method 500 proceeds to step 580.

If [d(vᵢ,t)²≧d(vᵢ,x)²+d(x,t)²] is false, method 500 proceeds to step 570 at which point candidate neighbor node x is classified as being part of the third subset N₃(vᵢ) of candidate neighbor nodes of current node vᵢ. From step 570, method 500 proceeds to step 580.

At step 580, a determination is made as to whether the final candidate neighbor node of the set of candidate neighbor nodes C(vᵢ) has been classified.

If the final candidate neighbor node of the set of candidate neighbor nodes C(vᵢ) has not been classified, method 500 returns to step 520, at which point a next candidate neighbor node x is selected from the set of candidate neighbor nodes C(vᵢ).

If the final candidate neighbor node of the set of candidate neighbor nodes C(vᵢ) has been classified, method 500 proceeds to step 590, at which point method 500 ends.

In general, use of method 500 of FIG. 5 for classifying the candidate neighbor nodes in the set of candidate neighbor nodes C(vᵢ) may be better understood by considering a lemma (which defines a property of the RGF capability which indicates that in any graph G, there is a successful RGF path p(v₀, t) between two nodes v₀ and t, which is at most [tan(45°+(Λ/2))]. d(v₀,t) where, for all i, aᵢ≦Λ for a max-threshold angle Λ<90°. A proof of this lemma follows. The proof of the lemma and, thus, the use of the lemma in determining the candidate neighbor node classification process depicted and described with respect to FIG. 5, may be better understood with respect to FIG. 6.

FIG. 6 depicts the geometry associated with the candidate neighbor node classification process depicted and described with respect to FIG. 5.

As depicted in FIG. 6, certain geometry, associated with a first circle ζ(vᵢ, t) whose diameter is line (vᵢ, t) and a second circle φ(vᵢ₊₁, t) whose radius is line (vᵢ₊₁, t), is depicted. This includes indications of points pᵢ, qᵢ, zᵢ, and z. This also includes angles αᵢ, Λ, βᵢ, and Λ′.

As noted above, the geometry of FIG. 6 is used to show the proof of the lemma, a description of which follows.

For this lemma, it is noted node vᵢ₊can be angularly projected to a point zᵢ on line (vᵢ,z) and also perpendicularly projected to a point qᵢ on line (vᵢ,t).

For this lemma, it also is noted that αᵢ≦Λ=∠zvᵢt, βᵢ≦Λ′=∠zᵢtvᵢ, and Λ′≦90°−Λ.

For this lemma, it also is noted that αᵢ+βᵢ≦90°,

$$∠ {v}_{i + 1} {p}_{i} {v}_{i} = 90 ° + \frac{{β}_{i}}{2} ,$$

and d(vᵢ,pᵢ)=xᵢ.

By the law of sines:

$$\begin{matrix}{x}_{i} + d ( {p}_{i} , {q}_{i} ) = sin ( 90 ° - {α}_{i} ) d ( {v}_{i + 1} , {q}_{i} ) / sin ( {α}_{i} ) \\ = sin ( 90 ° - {α}_{i} ) sin ( 90 ° - \frac{{β}_{i}}{2} ) d ( {v}_{i + 1} , {p}_{i} ) / sin ( {α}_{i} ) \\ = cos ( {α}_{i} ) cos ( \frac{{β}_{i}}{2} ) d ( {v}_{i + 1} , {p}_{i} ) / sin ( {α}_{i} ) .\end{matrix}$$

$$\begin{matrix}{x}_{i} = sin ( 90 ° - {α}_{i} - \frac{{β}_{i}}{2} ) d ( {v}_{i + 1} , {p}_{i} ) / sin ( {α}_{i} ) \\ = cos ( {α}_{i} + \frac{{β}_{i}}{2} ) d ( {v}_{i + 1} , {p}_{i} ) / sin ( {α}_{i} ) .\end{matrix}$$

$$( {x}_{i} + d ( {p}_{i} , {q}_{i} ) ) / {x}_{i} = cos ( {α}_{i} ) cos ( \frac{{β}_{i}}{2} ) / cos ( {α}_{i} + \frac{{β}_{i}}{2} ) .$$

By right angle trigonometry:

$$\begin{matrix}d ( {v}_{i} , {v}_{i + 1} ) = ( {x}_{i} + d ( {p}_{i} , {q}_{i} ) ) / cos ( {α}_{i} ) \\ = {x}_{i} ( 1 + d ( {p}_{i} , {q}_{i} ) / {x}_{i} ) / cos ( {α}_{i} ) \\ = {x}_{i} cos ( \frac{{β}_{i}}{2} ) / cos ( {α}_{i} + \frac{{β}_{i}}{2} ) .\end{matrix}$$

Using the procedure to drive

$$d ( {v}_{i} , {v}_{i + 1} ) , d ( {v}_{i} , {z}_{i} ) = {x}_{i} cos ( \frac{{Λ}^{′}}{2} ) / cos ( Λ + \frac{{Λ}^{′}}{2} ) .$$

From the fact that

$$d ( {v}_{i} , {v}_{i + 1} ) \leq d ( {v}_{i} , {z}_{i} ) , d ( {v}_{i} , {v}_{i + 1} ) \leq {x}_{i} cos ( \frac{{Λ}^{′}}{2} ) / cos ( Λ + \frac{{Λ}^{′}}{2} ) .$$

By cosine addition formula:

$$cos ( \frac{{Λ}^{′}}{2} ) / cos ( Λ + \frac{{Λ}^{′}}{2} ) = cos ( \frac{{Λ}^{′}}{2} ) / ( cos ( Λ ) cos ( \frac{{Λ}^{′}}{2} ) - sin ( Λ ) sin ( \frac{{Λ}^{′}}{2} ) ) = 1 / ( cos ( Λ ) - sin ( Λ ) tan ( \frac{{Λ}^{′}}{2} ) ) .$$

Additionally,

$$\frac{{Λ}^{′}}{2} \leq \frac{90 ° - Λ}{2} \to tan ( \frac{{Λ}^{′}}{2} ) \leq tan ( \frac{90 ° - Λ}{2} ) .$$

Additionally,

$$1 / ( cos ( Λ ) - sin ( Λ ) tan ( \frac{{Λ}^{′}}{2} ) ) \leq 1 / ( cos ( Λ ) - sin ( Λ ) tan ( \frac{90 ° - Λ}{2} ) = cos ( 45 ° - \frac{Λ}{2} ) / ( cos ( Λ ) cos ( 45 ° - \frac{Λ}{2} ) - sin ( Λ ) sin ( 45 ° - \frac{Λ}{2} ) ) = sin ( 45 ° + \frac{Λ}{2} ) / cos ( 45 ° + \frac{Λ}{2} ) .$$

Thus

$$d ( {v}_{i} , {v}_{i + 1} ) \leq {x}_{i} cos ( \frac{{Λ}^{′}}{2} ) / cos ( Λ + \frac{{Λ}^{′}}{2} ) \leq {x}_{i} tan ( 45 ° + \frac{Λ}{2} ) .$$

Thus,

$$p ( s , t ) = {\sum }_{i = 0}^{n - 1} d ( {v}_{i} , {v}_{i + 1} ) \leq {\sum }_{i = 0}^{n - 1} {x}_{i} tan ( 45 ° + \frac{Λ}{2} ) \leq tan ( 45 ° + \frac{Λ}{2} ) d ( s , t ) .$$

As noted above, a result from the proof of this lemma is that d(vᵢ,vᵢ₊₁)=xᵢ cos(βᵢ/2)/cos(αᵢ+βᵢ/2)≦tan(45°+(Λ/2)). In one embodiment, as noted hereinabove, this result is used in defining method 500 of FIG. 5.

As also noted above, the geometry of FIG. 6 may be used in providing the candidate neighbor node classification process depicted and described with respect to FIG. 5.

FIG. 7 depicts one embodiment of a method for determining routing of packets at a current node using three disjoint subsets of candidate neighbor nodes as determined in FIG. 5. As noted above, in one embodiment, method 700 is suitable for use as step 430 of FIG. 4.

At step 710, method 700 begins.

At step 720, a determination is made as to whether the first subset of candidate neighbor nodes Nᵢ(vᵢ) is null.

If the first subset of candidate neighbor nodes N₁(vᵢ) is not null, method 700 proceeds to step 730, at which point one of the candidate neighbor nodes in the first subset of candidate neighbor nodes N₁(vᵢ) is selected as the next-hop node. From step 730, method 700 proceeds to step 790, where method 700 ends.

If the first subset of candidate neighbor nodes N₁(vᵢ) is null, method 700 proceeds to step 740.

At step 740, a determination is made as to whether the second subset of candidate neighbor nodes N₂(vᵢ) is null.

If the second subset of candidate neighbor nodes N₂(vᵢ) is not null, method 700 proceeds to step 750, at which point one of the candidate neighbor nodes in the second subset of candidate neighbor nodes N_{2 (v}ᵢ) is selected as the next-hop node. From step 750, method 700 proceeds to step 790, where method 700 ends.

If the second subset of candidate neighbor nodes N₂(vᵢ) is null, method 700 proceeds to step 760.

At step 760, a determination is made as to whether the third subset of candidate neighbor nodes N₃(vᵢ) is null.

If the third subset of candidate neighbor nodes N₃(vᵢ) is not null, method 700 proceeds to step 770, at which point one of the candidate neighbor nodes in the third subset of candidate neighbor nodes N₃(vᵢ) is selected as the next-hop node. From step 770, method 700 proceeds to step 790, where method 700 ends.

If the third subset of candidate neighbor nodes N₃(vᵢ) is null, method 700 proceeds to step 780.

At step 780, the current node identifies itself as the destination node, such that no additional forwarding of packets is required. From step 780, method 700 proceeds to step 790, where method 700 ends.

At step 790, method 700 ends.

Although depicted and described as ending for purposes of clarity, it is noted that the current node may forward one or more packets based on the result of execution of method 700. For example, where the current node is not the destination node, the current node may forward one or more packets to the selected next-hop node. Similarly, for example, where the forwarding node is identified as being the destination node, the current node may provide one or more packets within the current node (e.g., to an upper layer for local processing of the packet(s)).

Although depicted and described with respect to an embodiment in which the subsets of candidate neighbor nodes are used to determine whether or not the current node is the destination node, it is noted that this determination also may be made without using the subsets of candidate neighbor nodes. For example, a current node may check address information of received packets and determine identify itself as the intended destination node prior to execution of one or more of the methods associated with the RGF capability.

In general, use of method 700 of FIG. 7 for selecting a next-hop node may be better understood by considering a theorem which indicates that, in any graph G^{DT} with a DT substrate, the RGF capability is guaranteed to reach any destination node. A description of the proof of the theorem follows. If the number of nodes N in G^{DT} is at most three, then the proof is trivial since all of the nodes in G^{DT} are directly connected to each other. If the number of nodes N in G^{DT} is greater than three, the proof is not as trivial. Accordingly, without loss of generality, assume that node vᵢhas a packet to be delivered to destination t which is not directly connected to vᵢ in G^{DT}. First, it is shown that within or on circle ζ(vᵢ, t) of node vᵢ, there exists at least one neighbor node. According to the triangle property of DT, each node in G^{DT} has at least two neighbors, and DT embedded in G^{DT} is planar and has convex triangulations. As a result, it is noted that in all edges incident on node vᵢ, if edge eᵣ(vᵢ, vᵣ) is directly clockwise of line (vᵢ, t) and edge eₗ(vᵢ, vₗ) is directly counter-clockwise of line (vᵢ, t), nodes vᵣ and vₗ are directly connected with each other through edge (vᵣ, vₗ) and also the edge (vᵣ, vₗ) is intersected by line (vᵢ, t). From this observation and the fact that DT has a dual graph of Voronoi diagram, either or both of the Voronoi cell of node vᵣ or the Voronoi cell of node vₗ have to be intersected by line (vᵢ, t). As a result of the equal-distance property of Voronoi edge, we ensure that each neighbor node within Voronoi cell intersected by line (vᵢ, t) is closer to node t than node vᵢ. That is, at least one of nodes vᵣ and vₗ is enclosed by circle φ(vᵢ, t) whose radius is line (vᵢ, t). However, assuming that it lies outside of the circle ζ(vᵢ, t) whose diameter is line (vᵢ, t), this would mean circle ζ(vᵢ, t) is an empty circle from the view point of node vᵢ, because, otherwise, the edge between node vᵢ and other neighbor nodes within or on ζ(vᵢ, t) must cross edge (vᵣ, vₗ). However, this is impossible due to the planar property of DT. As a result, line (vᵢ, t) has to be an edge of Gabriel Graph (GG) (where, for a given node set V, nodes x and y ∈ V are connected to each other if they are distinct and the closed disc whose line (x, y) is a diameter contains no other elements of V). From the fact that GG DT, it follows that line (vᵢ, t) is an edge of DT, but it is a contradiction that node vᵢ is not directly connected to node t in G^{DT}. Thus, it is concluded that the circle ζ(vᵢ, t) encloses at least one neighbor node. It is noted that, for the RGF mechanism, RGF traversal to any neighbor within or on the circle ζ(vi, t)) strictly and monotonically reduces Euclidean distance to destination t, such that there is no loop in a RGF path. As such, from the distance monotone property and the proof of generalized case of the theorem provided above, it follows that RGF guarantees to reaches any destination in G^{DT}.

A result from the proof of this theorem is that at least one neighbor node of current node vᵢ is in first subset of candidate neighbor nodes N₁(vᵢ) or second subset of candidate neighbor nodes N₂(vᵢ). In one embodiment, as noted hereinabove, this result is used in defining method 700 of FIG. 7.

It is noted that, in any given graph, RGF provably shows the worst-case bound in term of path length even though the bound is not competitive. This may be better understood by considering a lemma in which, in any graph G, if there is a successful RGF path p(v₀, t) between two nodes v₀ and t, p(v₀, t) in RGF is at most [d(v₀,t)·(d(v₀,t)+\sqrt{2}−1)/\sqrt{2}]. A proof of this lemma follows.

For this lemma, node vᵢ₊₁ can be angularly projected to a point pᵢ on line (vᵢ,t), and xᵢ and rᵢ₊₁ denote d(vᵢ, pᵢ) and d(vᵢ₊₁,t) respectively.

By triangle inequality, d(vᵢ,vᵢ₊₁)<xᵢ+d(vᵢ₊₁, pᵢ).

By the law of cosines and half-angle formulas:

$$d ( {v}_{i + 1} , {p}_{i} ) = {r}_{i + 1} \sqrt{2 ( 1 - cos ( {β}_{i} ) )} = 2 {r}_{i + 1} sin ( \frac{{β}_{i}}{2} ) ,$$

which is <2rᵢ₊₁\sqrt{2}/2 due to

$$\frac{{β}_{i}}{2} < 45 ° .$$

As a result, d(vᵢ, pᵢ)<xᵢ+rᵢ₊₁\sqrt{2}.

By assuming that RGF traversal stops at the k-th node that is visited, it may be determined that p(s,t)=Σᵢ₌₀ⁿ⁻¹d(vᵢ, vᵢ₊₁)<Σᵢ₌₀ⁿ⁻¹xᵢ+\sqrt{2}Σᵢ₌₀ⁿ⁻¹rᵢ₊₁=d(s,t)+\sqrt{2}Σᵢ₌₀ⁿ⁻¹(n−1−i)xᵢ₊₁. From this result, it may be determined that Σᵢ₌₀ⁿ⁻¹(n−1−i)xᵢ₊₁=(d(s,t))/2. From this result, it may be determined that p(s,t)<d(s,t)+\sqrt{2}(d(s,t)²−d(s,t))/2=d(s,t)(d(s,t)+\sqrt{2}−1)/\sqrt{2}.

As indicated above, in any given graph, RGF provably shows the worst-case bound in term of path length even though the bound is not competitive. It is noted that, from evaluations of the RGF using Λ=45°, ∀vᵢ: Nᵢ(vᵢ)≠0, RGF path length as compared to the Euclidean distance between the source-destination pairs is less than 2.03 (≦tan(45°+(Λ/2))≈2.414) in at least some graphs.

FIG. 8 depicts one embodiment of a method for classifying candidate neighbor nodes into four disjoint subsets of candidate neighbor nodes. As noted above, in one embodiment, method 800 is suitable for use as step 420 of FIG. 4. It is noted that various angles and other related properties depicted and described with respect to FIG. 8 may be better understood by way of reference to FIGS. 6 and 10.

At step 805, method 800 begins.

At step 810, a (next) candidate neighbor node x is selected from the set of candidate neighbor nodes C(vᵢ).

At step 815, a determination is made as to whether [[(cos(βᵢ/2))/(cos(αᵢ+βᵢ/2))≦tan(45°+(Λ/2))].

If [[cos(βᵢ/2))/(cos(αᵢ+/2))≦tan(45°+(Λ/2))] is true, method 800 proceeds to step 820, at which point candidate neighbor node x is classified as being part of the first subset C₁(vᵢ) of candidate neighbor nodes of current node vᵢ. From step 820, method 800 proceeds to step 840.

If [[(βᵢ/2))/(cos(αᵢ+/2))≦tan(45°+(Λ/2))] is false, method 800 proceeds to step 825.

At step 825, a determination is made as to whether [d(vᵢ,t)²≧d(vᵢ,x)²+d(x,t)²].

If [d(vᵢ,t)²≧d(vᵢ,x)²+d(x,t)²] is true, method 800 proceeds to step 830 at which point candidate neighbor node x is classified as being part of the third subset C₃(vᵢ) of candidate neighbor nodes of current node vᵢ. From step 830, method 800 proceeds to step 840.

If [d(vᵢ,t)²≧d(vᵢ,x)²+d(x,t)²] is false, method 800 proceeds to step 835 at which point candidate neighbor node x is classified as being part of the fourth subset C₄(vᵢ) of candidate neighbor nodes of current node vᵢ. From step 835, method 800 proceeds to step 840.

At step 840, a determination is made as to whether the final candidate neighbor node of the set of candidate neighbor nodes C(vᵢ) has been classified.

If the final candidate neighbor node of the set of candidate neighbor nodes C(vᵢ) has not been classified, method 800 returns to step 810, at which point a next candidate neighbor node x is selected from the set of candidate neighbor nodes C(vᵢ).

If the final candidate neighbor node of the set of candidate neighbor nodes C(vᵢ) has been classified, method 800 proceeds to step 845.

At step 845, a determination is made as to whether a triangle walk needs to be performed (e.g., denoted by checking whether the value of an exemplary variable “triangle_walking” is set to TRUE or FALSE). If a triangle walk needs to be performed, method 800 proceeds to step 850. If a triangle walk does not need to be performed, method 800 proceeds to step 855. A triangle walk may be better understood by way of reference to FIG. 10.

At step 850, the second subset C₂(vᵢ) of candidate neighbor nodes of current node vᵢis determined. In one embodiment, the third subset C₃(vᵢ) of candidate neighbor nodes of current node vᵢ is determined using method 900 depicted and described with respect to FIG. 9. From step 850, method 800 proceeds to step 865, at which point method 800 ends.

At step 855, a determination is made as to whether or not the first subset C₁(vᵢ) of candidate neighbor nodes of current node vᵢ is null. If the first subset C₁(vᵢ) of candidate neighbor nodes of current node vᵢ is not null, method 800 proceeds to step 865, at which point method 800 ends. If the first subset C₁(vᵢ) of candidate neighbor nodes of current node vᵢ is null, method 800 proceeds to step 860.

At step 860, a determination is made that a triangle walk needs to be performed (e.g., denoted by setting an exemplary variable “triangle_walking” to TRUE), the starting node for the triangle walk is changed from node ᵥᵢ to node vₖ, and method 800 proceeds to step 850 where the second subset C₂(vᵢ) of candidate neighbor nodes of current node vᵢ is determined (e.g., using method 900 depicted and described with respect to FIG. 9). From step 850, method 800 proceeds to step 865, at which point method 800 ends.

FIG. 9 depicts one embodiment of a method for determining the second subset of candidate neighbor nodes of the current node within the context of the method for classifying candidate neighbor nodes into four disjoint subsets of candidate neighbor nodes of FIG. 8. As noted above, in one embodiment, method 900 is suitable for use as step 850 of FIG. 8. It is noted that various angles and other related properties depicted and described with respect to FIG. 9 may be better understood by way of reference to FIGS. 6 and 10.

It is noted that method 900, which enables use of a triangle walk over a portion of a triangulated overlay network, is performed for the current node vᵢand a starting node vₖ for the triangle walk (denoted as triangle_walk_start_node vₖ). It is further noted that: (a) Tᵢ is the closest triangle to destination t among triangles which are crossed by v̅ₖ̅t̅ and incident on vᵢ and (b) Tᵢ₋₁ is the triangle incident to edge (vᵢ₋₁, vᵢ) walked just before reaching vᵢ and crossed by v̅ₖ̅t̅. These variables and conditions of FIG. 9 may be better understood by way of reference to FIG. 10, which depicts an exemplary triangle walk between a current node and a destination node.

At step 910, method 900 begins.

At step 920, a candidate neighbor node Y is selected from the third subset C₃(vᵢ) of candidate neighbor nodes of current node vᵢ.

At step 930, a determination is made as to whether candidate neighbor node Y is on triangle Tᵢ. If candidate neighbor node Y is not on triangle Tᵢ. method 900 proceeds to step 960, at which point a determination is made as to whether candidate neighbor node Y is the final candidate neighbor node in the third subset C₃(vᵢ) of candidate neighbor nodes. If candidate neighbor node Y is on triangle Tᵢ, method 900 proceeds to step 940.

At step 940, a determination is made as to whether candidate neighbor node Y is on triangle Tᵢ₋₁. candidate neighbor node Y is on triangle method 900 proceeds to step 960, at which point a determination is made as to whether candidate neighbor node Y is the final candidate neighbor node in the third subset C₃(vᵢ) of candidate neighbor nodes. If candidate neighbor node Y is not on triangle Tᵢ, method 900 proceeds to step 950,

At step 950, candidate neighbor node Y is classified as part of the second subset C₂(vᵢ) of candidate neighbor nodes of current node vᵢ. From step 950, method 900 proceeds to step 960.

At step 960, a determination is made as to whether the final candidate neighbor node of the third set of candidate neighbor nodes C₃(vᵢ) has been selected for processing.

If the final candidate neighbor node of the third set of candidate neighbor nodes C₃(vᵢ) has not been selected for processing, method 900 returns to step 920, at which point a next candidate neighbor node Y is selected from the third set of candidate neighbor nodes C₃(vᵢ).

If the final candidate neighbor node of the third set of candidate neighbor nodes C₃(vᵢ) has not been selected for processing, method 900 proceeds to step 970.

At step 970, method 900 ends.

FIG. 10 depicts an exemplary triangle walk between a current node and a destination node. It is noted that FIG. 5, FIG. 6, and FIG. 7 depict and describe operation of RGF until reaching a node vᵢ having a first subset C₁(vᵢ) of candidate neighbor nodes that is empty. At such a current forwarding node vᵢ, a triangle walk is initiated in order to walk across triangles intersected by a line segment between vᵢ and t (illustratively, Tᵢ, Tᵢ₊₁, Tᵢ₊₂, Tᵢ₊₃, Tᵢ₊₄, and Tᵢ₊₅ depicted in FIG. 10). For current forwarding node vᵢ and its set of neighbor nodes, two neighbor nodes on the closest triangle Tᵢ to t can be considered as the candidate next-hop nodes of current forwarding node vᵢ. By virtue of the theorem described hereinabove in conjunction with FIG. 6 and FIG. 7, either of the two candidate neighbor nodes is guaranteed to become the next-hop node of current forwarding node vᵢ.

FIG. 11 depicts one embodiment of a method for determining routing of packets at a current node using four disjoint subsets of candidate neighbor nodes as determined in FIGS. 8 and 9. As noted above, in one embodiment, method 1100 is suitable for use as step 430 of FIG. 4.

At step 1105, method 1100 begins.

At step 1110, a determination is made as to whether the first subset of candidate neighbor nodes C₁(vᵢ) is null.

If the first subset of candidate neighbor nodes C₁(vᵢ) is not null, method 1100 proceeds to step 1115, at which point one of the candidate neighbor nodes in the first subset of candidate neighbor nodes C₁(vᵢ) is selected as the next-hop node. From step 1115, method 1100 proceeds to step 1155, where method 1100 ends.

If the first subset of candidate neighbor nodes C₁(vᵢ) is null, method 1100 proceeds to step 1120.

At step 1120, a determination is made as to whether the second subset of candidate neighbor nodes C₂(vᵢ) is null.

If the second subset of candidate neighbor nodes C₂(vᵢ) is not null, method 1100 proceeds to step 1125, at which point one of the candidate neighbor nodes in the second subset of candidate neighbor nodes C₂(vᵢ) is selected as the next-hop node. From step 1125, method 1100 proceeds to step 1155, where method 1100 ends.

If the second subset of candidate neighbor nodes C₂(vᵢ) is null, method 1100 proceeds to step 1130.

At step 1130, a determination is made as to whether the third subset of candidate neighbor nodes C₃(vᵢ) is null.

If the third subset of candidate neighbor nodes C₃(vᵢ) is not null, method 1100 proceeds to step 1135, at which point one of the candidate neighbor nodes in the third subset of candidate neighbor nodes C₃(vᵢ) is selected as the next-hop node. From step 1135, method 1100 proceeds to step 1155, where method 1100 ends.

If the third subset of candidate neighbor nodes C₃(vᵢ) is null, method 1100 proceeds to step 1140.

At step 1140, a determination is made as to whether the fourth subset of candidate neighbor nodes C₄(vᵢ) is null.

If the fourth subset of candidate neighbor nodes C₄(vᵢ) is not null, method 1100 proceeds to step 1145, at which point one of the candidate neighbor nodes in the fourth subset of candidate neighbor nodes C₄(vᵢ) is selected as the next-hop node. From step 1145, method 1100 proceeds to step 1155, where method 1100 ends.

If the fourth subset of candidate neighbor nodes C₄(vᵢ) is null, method 1100 proceeds to step 1150.

At step 1150, the current node identifies itself as the destination node, such that no additional forwarding of packets is required. From step 1150, method 1100 proceeds to step 1155, where method 1100 ends.

At step 1155, method 1100 ends.

Although primarily depicted and described herein with respect to embodiments in which processing (e.g., various methods depicted and described herein) is performed by the current node vᵢ, in one embodiment some or all of the processing may be performed by one or more nodes other than the current node vᵢ. For example, some or all of the processing may be performed by one or more of one or more other nodes 110 of triangulated overlay network 100, one or more management systems associated with triangulated overlay network 100, any other suitable node or nodes, and the like, as well as various combinations thereof. In such embodiments, the node or nodes which perform the processing provide the results of the processing to current node vᵢ for use in determining routing of packets at current node vᵢ.

Although primarily depicted and described herein with respect to embodiments in which the RGF capability is provided for a specific type of communication network (namely, a triangulated overlay network), it is noted that various embodiments of the RGF capability may be provided within any other suitable type(s) of communication networks.

Although primarily depicted and described herein with respect to embodiments in which the RGF capability is provided using a graph-based representation of the layout of the network, it is noted that that various embodiments of the RGF capability may be provided using other suitable types of representations to represent the layout of the network.

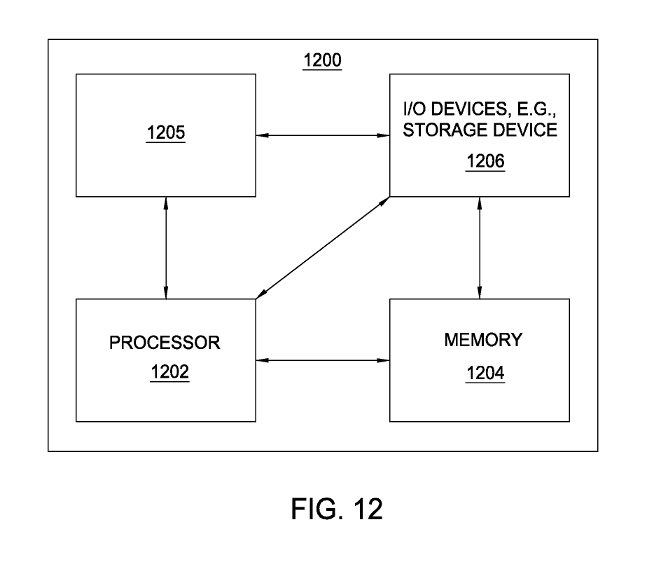

FIG. 12 depicts a high-level block diagram of a computer suitable for use in performing functions described herein.

As depicted in FIG. 12, computer 1200 includes a processor element 1202 (e.g., a central processing unit (CPU) and/or other suitable processor(s)) and a memory 1204 (e.g., random access memory (RAM), read only memory (ROM), and the like). The computer 1200 also may include a cooperating module/process 1205 and/or various input/output devices 1206 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software (e.g., via implementation of software on one or more processors) and/or hardware (e.g., using a general purpose computer, one or more application specific integrated circuits (ASIC), and/or any other hardware equivalents).

It will be appreciated that the functions depicted and described herein may be implemented in software for executing on a general purpose computer (e.g., via execution by one or more processors) so as to implement a special purpose computer, and/or may be implemented in hardware (e.g., using one or more application specific integrated circuits (ASIC) and/or one or more other hardware equivalents).

In one embodiment, the cooperating process 12 can be loaded into memory 1204 and executed by processor 1202 to implement functions as discussed herein. Thus, cooperating process 1205 (including associated data structures) can be stored on a computer readable storage medium, e.g., RAM memory, magnetic or optical drive or diskette, and the like.

It will be appreciated that computer 1200 depicted in FIG. 12 provides a general architecture and functionality suitable for implementing functional elements described herein and/or portions of functional elements described herein. For example, the computer 1200 provides a general architecture and functionality suitable for implementing one or more of the nodes 110.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according

Although various embodiments which incorporate the teachings of the present invention have been shown and described in detail herein, those skilled in the art can readily devise many other varied embodiments that still incorporate these teachings.

What is claimed is:

1. An apparatus for determining packet routing at a current node having a plurality of neighbor nodes associated therewith, the apparatus comprising:
a processor and a memory communicatively coupled to the processor, the processor configured to:
determine a set of candidate neighbor nodes of the current node from a representation of respective locations of the neighbor nodes, wherein the set of candidate neighbor nodes comprises each of the neighbor nodes located at least within a circle defined within the representation and having a diameter defined by a line between the current node and a destination node of the packet; and
determine packet routing at the current node using the set of candidate neighbor nodes.

2. The apparatus of claim 1, wherein the set of candidate neighbor nodes comprises each of the neighbor nodes of the current node located within and on the circle having a diameter defined by the line between the current node and the intended destination node.

3. The apparatus of claim 1, wherein, to determine packet routing using the set of candidate neighbor nodes, the processor is configured to:
classify the candidate neighbor nodes into three disjoint subsets of candidate neighbor nodes; and
determine packet routing using the three disjoint subsets of candidate neighbor nodes.

4. The apparatus of claim 3, wherein the three disjoint subsets of candidate neighbor nodes include a first subset of candidate neighbor nodes, a second subset of candidate neighbor nodes, and a third subset of candidate neighbor nodes.

5. The apparatus of claim 4, wherein, to classify the candidate neighbor nodes, the processor is configured to:
determine whether [[cos(βᵢ/2))/(cos(αᵢ+/2))/(cos(αᵢ+βᵢ/2))≦tan(45°+Λ/2)] is true; and
when [[cos(βᵢ/2))/(cos(αᵢ+βᵢ/2))≦tan(45°+(Λ/2)] is true, classify the candidate neighbor node as being part of the first subset of candidate neighbor nodes.

6. The apparatus of claim 5, wherein, to classify the candidate neighbor nodes, the processor is further configured to:
when [[cos(βᵢ/2))/(cos(αᵢ+βᵢ/2))≦tan(45°+Λ/2))] is false, determine whether [d(vᵢ,t)²≧d(vᵢ,x)²+d(x,t)²] is true; and
when [d(vᵢ,t)²≧d(vᵢ,x)²+d(x,t)²] is true, classify the candidate neighbor node as being part of the second subset of candidate neighbor nodes; or
when [d(vᵢ,t)²≧d(vᵢ,x)²+d(x,t)²] is false, classify the candidate neighbor node as being part of the third subset of candidate neighbor nodes.

7. The apparatus of claim 4, wherein, to determine packet routing using the subsets of candidate neighbor node, the processor is configured to:
select the next-hop node from the first subset of candidate neighbor nodes when the first subset of candidate neighbor nodes is not empty;
select the next-hop node from the second subset of candidate neighbor nodes when the first subset of candidate neighbor nodes is empty and the second subset of candidate neighbor nodes is not empty;
select the next-hop node from the third subset of candidate neighbor nodes when the first and second subsets of candidate neighbor nodes are empty and the third subset of candidate neighbor nodes is not empty; and
identify the current node as the destination node when the first, second, and third subsets of candidate neighbor nodes are empty.

8. The apparatus of claim 1, wherein, to determine packet routing using the set of candidate neighbor nodes, the processor is configured to:
classify the candidate neighbor nodes into four disjoint subsets of candidate neighbor nodes; and
determine packet routing using the four disjoint subsets of candidate neighbor nodes.

9. The apparatus of claim 8, wherein the four disjoint subsets of candidate neighbor nodes include a first subset of candidate neighbor nodes, a second subset of candidate neighbor nodes, a third subset of candidate neighbor nodes, and a fourth subset of candidate neighbor nodes.

10. The apparatus of claim 9, wherein the candidate neighbor nodes are initially classified into the first subset of candidate neighbor nodes, the third subset of candidate neighbor nodes, and the fourth subset of candidate neighbor nodes.

11. The apparatus of claim 10, wherein the third subset of candidate neighbor nodes is processed for reclassifying one or more of the candidate neighbor nodes of the third subset of candidate neighbor nodes from being classified in the third subset of candidate neighbor nodes to being classified in the second subset of candidate neighbor nodes.

12. The apparatus of claim 9, wherein, to classify the candidate neighbor nodes, the processor is configured to:
determine whether [[cos(βᵢ/2))/(cos(αᵢ+βᵢ/2))≦tan(45°+Λ/2)] is true; and
when [[cos(βᵢ/2))/(cos(αᵢ+βᵢ/2))≦tan(45°+Λ/2)] is true, classify the candidate neighbor node as being part of the first subset of candidate neighbor nodes.

13. The apparatus of claim 12, wherein, to classify the candidate neighbor nodes, the processor is further configured to:
when [[cos(βᵢ/2))/(cos(αᵢ+βᵢ/2))≦tan(45°+Λ/2))] is false, determine whether [d(vᵢ,t)²≦d(vᵢ,x)²+d(x,t)²] is true; and
when [d(vᵢ,t)²≦d(vᵢ,x)²+d(x,t)²] is true, classify the candidate neighbor node as being part of the third subset of candidate neighbor nodes; or
when [d(vᵢ,t)²≦d(vᵢ,x)²+d(x,t)²] is false, classify the candidate neighbor node as being part of the fourth subset of candidate neighbor nodes.

14. The apparatus of claim 13, wherein, to classify the candidate neighbor nodes, the processor is further configured to:
determine the second subset of candidate neighbor nodes using the third subset of candidate neighbor nodes.

15. The apparatus of claim 14, wherein the processor is configured to determine the second subset of candidate neighbor nodes using the third subset of candidate neighbor nodes in response to a determination to perform a triangle walking process for the current node.

16. The apparatus of claim 14, wherein the processor is configured to determine the second subset of candidate neighbor nodes using the third subset of candidate neighbor nodes in response to a determination not to perform a triangle walking process for the current node and a determination that the first subset of candidate neighbor nodes is null.

17. The apparatus of claim 9, wherein, to determine packet routing using the subsets of candidate neighbor nodes, the processor is configured to:
select the next-hop node from the first subset of candidate neighbor nodes when the first subset of candidate neighbor nodes is not empty;
select the next-hop node from the second subset of candidate neighbor nodes when the first subset of candidate neighbor nodes is empty and the second subset of candidate neighbor nodes is not empty;
select the next-hop node from the third subset of candidate neighbor nodes when the first and second subsets of candidate neighbor nodes are empty and the third subset of candidate neighbor nodes is not empty;
select the next-hop node from the fourth subset of candidate neighbor nodes when the first, second, and third subsets of candidate neighbor nodes are empty and the fourth subset of candidate neighbor nodes is not empty; and
identify the current node as the destination node when the first, second, third, and fourth subsets of candidate neighbor nodes are empty.

18. The apparatus of claim 1, wherein the representation is a graph having a Delaunay Triangulation (DT) substrate.

19. A method for determining packet routing at a current node having a plurality of neighbor nodes associated therewith, the method comprising:
using a processor for:
determining a set of candidate neighbor nodes of the current node from a representation of respective locations of the neighbor nodes, wherein the set of candidate neighbor nodes comprises each of the neighbor nodes located at least within a circle defined within the representation and having a diameter defined by a line between the current node and a destination node of the packet; and
determining packet routing at the current node using the set of candidate neighbor nodes.

20. A computer-readable storage medium storing instructions which, when executed by a computer, cause the computer to perform a method for determining packet routing at a current node having a plurality of neighbor nodes associated therewith, the method comprising:
determining a set of candidate neighbor nodes of the current node from a representation of respective locations of the neighbor nodes, wherein the set of candidate neighbor nodes comprises each of the neighbor nodes located at least within a circle defined within the representation and having a diameter defined by a line between the current node and a destination node of the packet; and
determining packet routing at the current node using the set of candidate neighbor nodes.
